(19) United States
(12) Patent Application Publication
(10) Pub. No.: US 2007/0075130 A1
(43) Pub. Date: Apr. 5, 2007

(54) Mid-Level Local Biometric Identification Credit Card Security System

(75) Inventor: Henry George Potrykus, Alexandria, VA (US)

Correspondence Address: HENRY G. POTRYKUS, 3001 PARK CENTER DRIVE, APT. 119, ALEXANDRIA, VA, 22302, US

(73) Assignee: Henry George Potrykus, Alexandria, VA (US)

(21) Appl. No.: 11/163,021

(22) Filed: Oct. 3, 2005

(51) Int. Cl. G06K 5/00; G06Q 40/00

(52) U.S. Cl. 235/380; 705/44

(57) ABSTRACT

A method for providing secure transactions with credit cards by adding a fingerprint scanner at the point-of-sale to obtain personal information. The scanner will be integrated with a simple hardware processing device that will process and encode the personal information and compare it to encoded biometric information of the cardholder stored on the card's magnetic strip. This encoding may provide various levels of cryptographic security, but should be able to be processed locally. Thus a simple scanner and processing device on-site can verify that the user of the card is the same person to whom the card is issued. The scanner and processing device can be integrated with existing transaction negotiation protocols in such a way that the correspondence of user personal information to cardholder biometric information will be a prerequisite for any subsequent transmission of credit card information. The processing and encoding of both the scanned personal information and the biometric information to be stored on the magnetic strip will ensure a level of confidentiality of the cardholders biometric information as will the fact that the correspondence of the two information sets is checked locally.

### BACKGROUND OF THE INVENTION

1. Field of the Invention

This invention relates to biometric security systems designed to be incorporated with magnetic strip credit cards and their processors. More precisely it relates a local, point-of-sale biometric identity verification to the standard point of sale authentication of a credit card transaction.

2. Other Background and Related Technology

Credit card companies, banks and consumers holding various financial accounts are the victims of criminal acts relating to fraudulent use of account holder cards issued by the banks, and other institutions. The frequent commission of this type of fraud, especially due to stolen cards is origin to billions of dollars and millions of hours in loss to consumers, banks and retail businesses each year. Security techniques and technologies that have been proposed thus far to mitigate such losses are either not cost-effective or not secure enough to effectively prevent the widespread fraudulent use of credit cards and other magnetic strip cards.

Many types of security systems have been proposed to deal with theft-related fraud. Generally, these seek to establish either the authenticity and possession of the card itself or that the user of the card is the account holder of the card. Card verification and authenticity security techniques include so-called smart card technology, as well as extra number codes (Cardmember Identification Numbers, Card Verification Values, etc.), holograms, and tamper evident signature panels. Techniques to verify that the user is the person who is entitled to use the card include Personal Identification Numbers (PINs) and code words, both of which verify that the card user knows a particular piece of information that only the account holder should know. Also proposed are biometric security devices, which verify directly that the person in question is the person who is the account holder.

These techniques have proven to be inadequate to the problem, as ongoing credit card fraud suggests. Security techniques that verify card possession and authenticity are able to be circumvented by theft of the card. Those which rely on knowledge of a particular fact are similarly vulnerable as the private information may be compromised or stolen. Biometric information promises a higher level of security, since it establishes the identity of the card user and may relate it to information that the company possesses about the account holder.

Problems persist, however, with the implementation of biometric technology as a security measure for standard magnetic card technology. Various schemes have been proposed to link biometric security methods with credit cards. A typical example is the invention of Ofer Gottfried (U.S. Pat. No. 6,270,011), which provides for a system that collects biometric (specifically fingerprint) information and transmits it to the corporate database for verification along with the account information. Another technological attempt to solve the problem of integrating biometric technology and credit card technology is that of Charles Bogosian (U.S. Pat. No. 5,513,272), which includes the steps of scanning the card for a bar code, for evidence of tampering, and scanning at least one fingerprint on the card, and any other detectable information, and comparing the scanned information on the card to information stored on a database. Other systems have tried to put the biometric information on a smart card and have even tried to incorporate a fingerprint scanner onto the card itself, thus preventing a stolen card from being used by someone other than its proper user.

Fingerprint biometric verification takes place in a variety of ways. Frequently, the data of the fingerprint is broken up into a numerical representation of the major features, minutiae, borders, ridge counts, ridge flows, or some combination thereof. This numerical representation is compared to fingerprints in a database either in a one-to-one search or a one-to-many search. In one-to-many search the fingerprint is compared to the fingerprints stored in a database until a match is found. In a one-to-one search one fingerprint is compared to a single fingerprint found by some other criterion in a database (such as a name or account number) or to a single fingerprint taken from some other place. Proposals for using fingerprints for credit card security are universally matched in a one-to-one process. The desired end of all these systems is to establish an exact match between the pre-stored fingerprint and the fingerprint of the card user so that one may infer that the person using the card and the person holding the account are one and the same.

These, and other solutions, have a variety of problems that have prevented their implementation in the market. They are too complicated, with relatively large data set storage required. They are also too expensive, with large infrastructure or media investments or many changes to business operations being necessary. Additionally, they subject the account holder's personal biometric information to unwarranted risk. This relates to their having set their security goals incorrectly, each attempting to provide complete security rather than adequate and economically feasible security, which will be strong enough to fool almost all criminals. Thus a system that is built on existing magnetic strip technology and which verifies identity locally using personal information and that is adequately secure is desirable.

### SUMMARY OF THE INVENTION

The invention may be understood as the prototypical mid-level local biometric identification (MLLBI) system for credit card security. It is mid-level since it seeks to establish sufficiently likely rather than completely certain match of the user of the card via processed biometric information. Said processing is through modern techniques of digital signal and image processing, which have heretofore not been exploited by other similar inventions. It is local because all processing of the biometric is handled onsite.

In accordance with a preferred embodiment of the present invention, there is provided a method for local credit card authentication comprising the steps of:
initiating a purchase transaction in which a purchaser provides credit card information, this including encoded fingerprint biometric information at the point of sale, and the purchaser's own personal fingerprint information to the MLLBI;
processing said personal fingerprint information to match it with said fingerprint biometric information from said credit card;
providing a message to said point of sale or to a local electronic cash register or both disclosing successful or unsuccessful match;
communicating said credit card information to an electronic cash register along with unsuccessful match information, if applicable; and
given successful match, relaying a standard authorization message to said point of sale or to a local electronic cash register or both for completion of said purchase transaction.

The MLLBI operation is based on use of a human fingerprint and a secure algorithm for verifying that the purchaser is the one whose biometric information is contained on card.

The fingerprint scanner will use industry standard technology, such as the capacitive devices available from Biometrix Int or NEC or optical devices available from Biolink USA or BiometricID. The small size of the data associated with the fingerprint biometric information is based on the use of digital signal processing algorithms involving statistical and digital signal and image processing metrics, statistics, measures, invariants, and other derivatives including computing means, variances, deviations, vectors, tensors, correlation functions and the like of filtering results.

Fingerprint identification, which has been a widely accepted personal identification method for over 100 years, is normally based on the fact that ridge characteristics such as ridge endings and ridge bifurcations (usually referred to as minutia) are unchangeable and repeatable features of each individually unique fingerprint. Comparison of two fingerprints to show coincidence of these features can be made to a precision far greater than those necessary for the application described here. Automated systems using image capture and image processing and statistical analyses are part of the technology described above, are now feasible as is known by those skilled in the art of digital signal processing, and avoid the requirement of directly identifying and locating either the ridges or the ridge endings or bifurcations.

This invention consists primarily in two physical parts and an encoding technique. The first physical part is a stand-alone fingerprint scanner and processor that is meant to be installed in serial with existing credit card reading technology, or, in the future, it will exist as a component of a new credit card reader. The second physical part is the card itself which will contain the additional information on the magnetic strip. The encoding technique is the application of statistical and digital signal and image processing metrics, statistics, measures, invariants, or other derivatives including computing means, variances, deviations, vectors, tensors, or correlation functions and the like of filtering results. The encoding technique can involve the optional hashing of the above results.

One of the primary advantages of this system is the ease with which it may be integrated to existing systems. The scanning and processing component may be easily installed in series with current credit card reading and transaction logging technology, thus permitting the use of existing infrastructure and cutting initial hardware costs. Additionally, the digital signal processing and encoding of the fingerprint result in a greatly reduced amount of storage space taken up, thus allowing for the placement of the fingerprint information on the currently existing widespread magnetic strip technology, without the need of “smart chip” or other such expensive storage technology.

Another advantage of this technology is the additional privacy afforded to the user. While the fingerprint information on the card and local verification of the fingerprint information make the card practically impossible for a thief to use, the original fingerprint itself is not able to be recovered except from the person. Bogosian's invention calls for the storage of a fingerprint on the card itself, presenting a clear security risk that the information could be stolen with the card. Gottfried's system calls for the maintenance of a large database of fingerprints to be kept by the credit card company for the purpose of verification. This too represents a security risk, since the database could be cracked and a large number of people's personal and biometric information could be subject to theft and malicious application, a risk that is not desired by businesses, financial institutions, governments or consumers. Gottfried's system is also problematic since it seeks to make a one-to-one match between the card holder and the information on the database. This is computationally a much more difficult problem affording a less elegant solution than the problems solved given the computational techniques used in this invention. It also involves transmission and storage of a large amount of information.

Dexter L. Meadows, II, et.al. (U.S. Pat. No. 5,869,822) have proposed a similar system to this one, insofar as it is modular, easily incorporated with the existing hardware infrastructure and contained the idea of putting the fingerprint on a card's magnetic strip to allow for local verification. However, the system proposed here offers distinct advantages over the Meadows system. The Meadows system's process is based upon a specific ridge-counting algorithm, the system proposed here uses more sophisticated, more general, and more robust processing techniques and is more flexible in the sense that these advanced means for computing the biometric measures, statistics, and derivatives may be modified over time to allow the maturation of the comparison process. The patent of Gagne, et al. (U.S. Pat. No. 5,363,453) is similarly based on a specific ridge counting algorithm.

The system described here makes the original fingerprint information impossible to steal from either the card or a company database for the simple fact that neither the company nor the card hold the original information. This system avoids the usual, more complicated techniques that seek to preform a precise fingerprint analysis for the sake of a one-to-many or one-to-one matching. Instead it uses a matching algorithm that may match a class of personal fingerprint information to a biometric fingerprint information set on the user's card. This is essentially a many-to-one match scheme that will allow for reduced memory loads on the cards, thus permitting the preservation of existing card technology. The technique involved in this technology also eliminates the risk of the biometric information being stolen.

### BRIEF DESCRIPTION OF THE DRAWINGS

For a better understanding of the invention with regard to the embodiments thereof, reference is made to the accompanying drawings, in which like numerals designate corresponding elements or sections throughout, and in which:

FIG. 1 is a diagram of a prior art credit card transaction system architecture;

FIG. 2 is a diagram of a credit card authorization system architecture constructed in accordance with the principles of the present invention;

FIG. 3 is an architectural diagram of a preferred embodiment of a MLLBI system constructed and operated in accordance with the principles of the present invention;

FIG. 4 is a sequence diagram describing the exchange of messages of the system of FIGS. 2-3 for a successful MATCH use case;

FIG. 5 is a sequence diagram describing the exchange of messages of the system of FIGS. 2-3 for a NOMATCH use case;

FIG. 6 is a state diagram showing the basic operating states of the MLLBI.

### DETAILED DESCRIPTION OF A PREFERRED EMBODIMENT

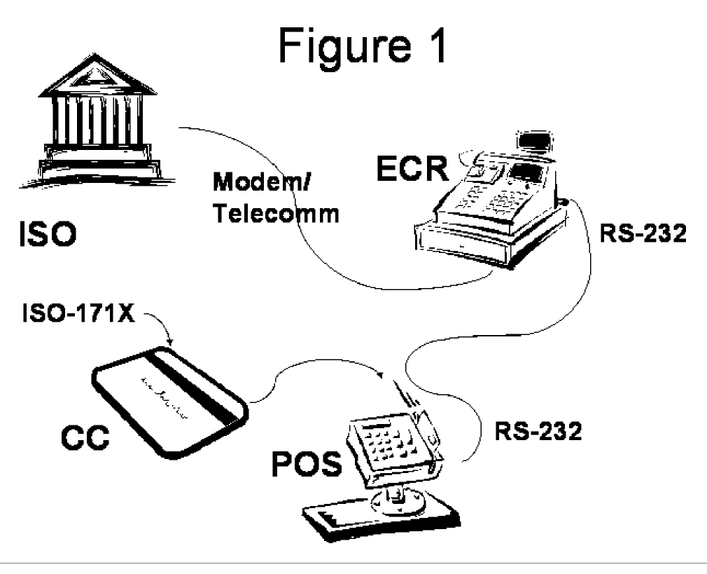

In FIG. 1, there is shown a diagram of a current credit card transaction authorization system. This system is composed of a credit card (CC), which is a plastic card bearing a magnetic stripe which is encoded with biometric and account information. The industry standard card type is described in the ISO-171X standards family. The magnetic stripe card is to be run through the reading device at the point of sale (POS), POS reads the data from the card in accord with said standards family. Said read data is encoded by the magnetic stripe card reader and communicated across an RS-232 datalink, USB datalink or similar standard datalink to the Electronic Cash Register (ECR) device. The ECR communicates by dial-up modem or some other standard telecommunications medium with the acquiring bank or independent sales organization (ISO) to transmit and receive data concerning the credit card transaction.

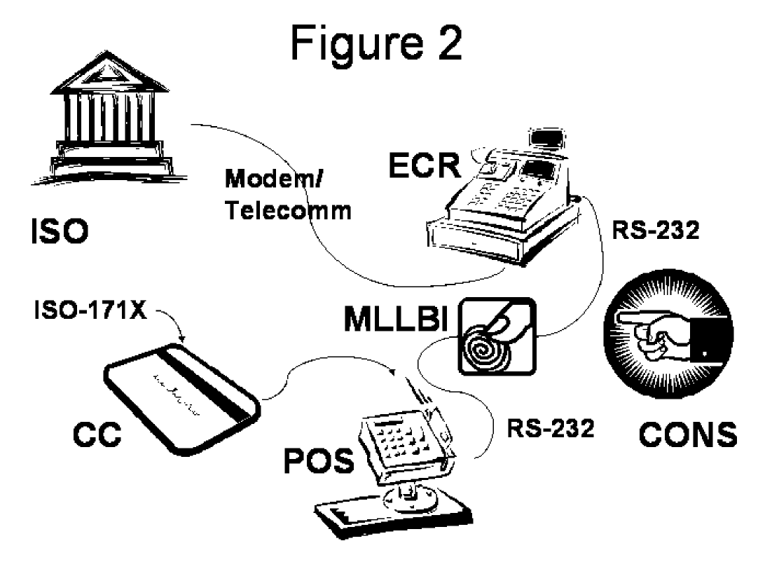

FIG. 2 modifies this architecture by inserting in series an MLLBI between the POS and the ECR to mediate the transaction between the POS and the ECR, as well as to obtain biometrics information read from the credit card by the POS and to compare said biometrics information with that provided by processing the personal fingerprint information from a consumer (CONS).

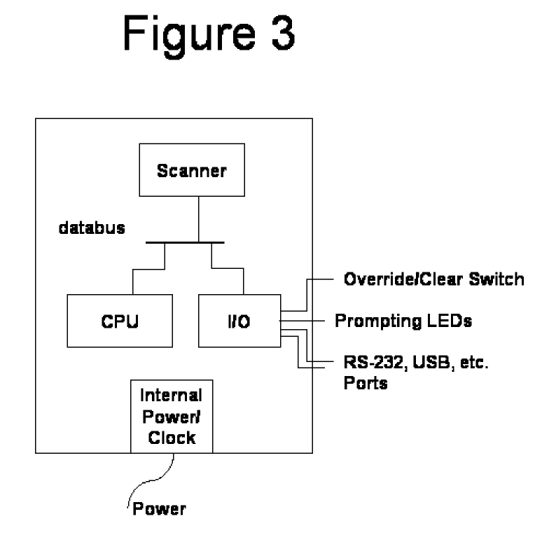

The hardware component of the system is depicted in FIG. 3. It is composed of a fingerprint scanner, a Central Processing Unit (CPU), and an Input/Output (I/O) device linked by a data bus and connected to a power source. Typically the CPU and I/O units will comprise a PIC (with its standard I/O capabilities-notably USB), and any other bulk chipset, pin-sets, wiring and busing, and ports will be integral to said hardware component to make the system an integrated whole. In particular, said pin-sets, wiring and busing must also connect the Fingerprint scanner electrically to the assemblage so that data communications transfer will occur. The fingerprint scanner will relay a digitized signal representation of the fingerprint information through said bus to the CPU.

The CPU, a chip such as a PIC microcontroller, will be programmed with the algorithm which will process the scanned fingerprint information to extract the digital signal processing measures and metrics. This information will be compared to the biometrics information taken from the credit card information and supplied to the system by the I/O device. The hardware component will also receive and relay the credit card information from the POS to through the I/O device to the ERC and vice-versa.

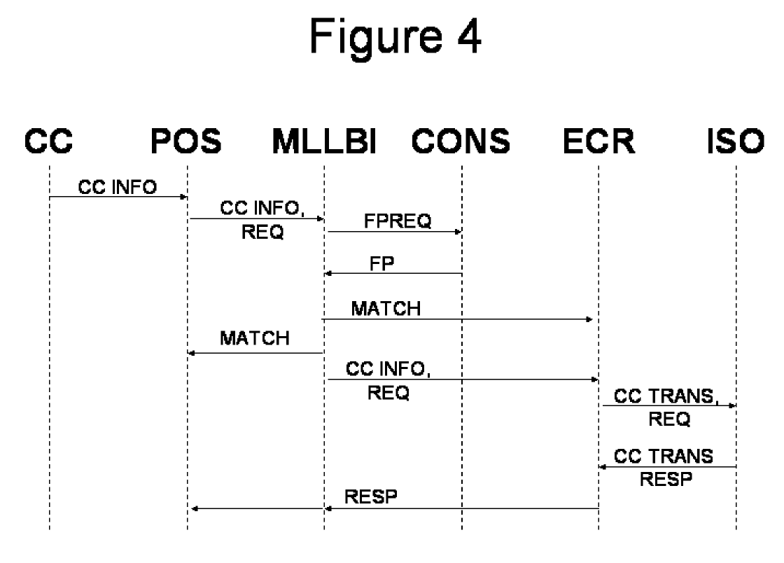

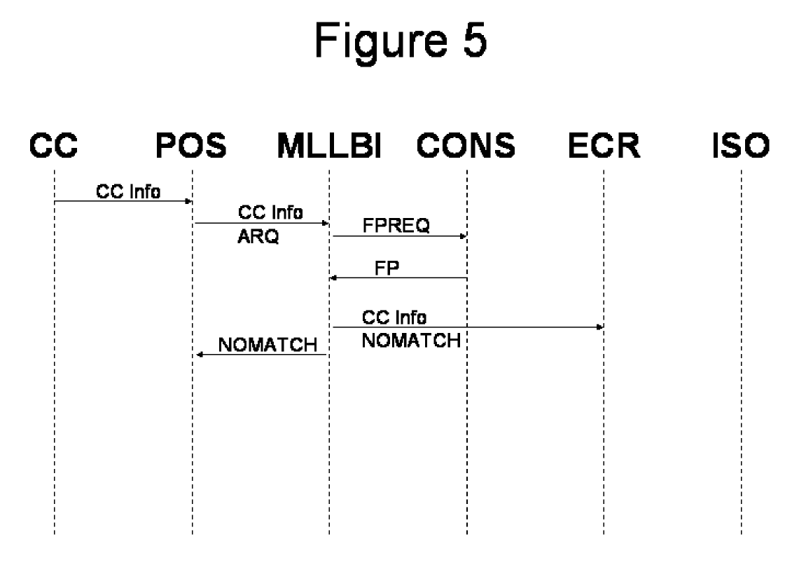

FIG. 4 and FIG. 5 depict summary sequence diagrams for the reading of credit card information (CC INFO) from CC by POS, the transmission of CC INFO and any other standard handshake or response request (RESP) from POS to MLLBI, the transmission of a message requesting the fingerprint information (FPREQ) of the CONS-this message may be a light emitting diode (LED) sequence or may be a text message mediated by POS, the provision of personal fingerprint information (FP) by CONS to the MLLBI given as a depressed finger chosen by CONS and scanned by the fingerprint scanner device which is a part of MLLBI, the transmission of a message indicating match successful (MATCH) if the biometric information on the credit card matches that of the processed FP and the continuation of the credit card transaction as is done in the standard credit card transaction authorization scheme, as depicted in FIG. 4, or the transmission of a message indicating match unsuccessful (NOMATCH) if the biometric information on the credit card does not matches that of the processed FP and the termination of the credit card transaction authorization process as is depicted in FIG. 5.

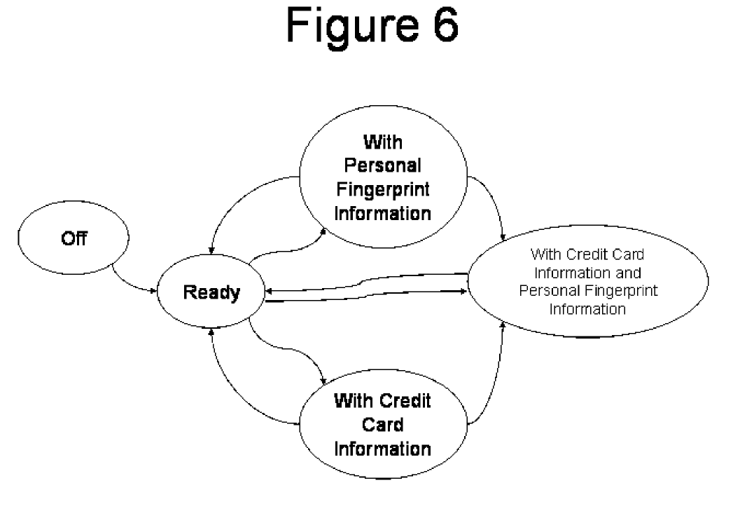

FIG. 6 presents the state diagram for the MLLBI. The Ready state is attained either through powering on the device or through time-out or reset/override I/O signal from states With Credit Card Information and With Personal Fingerprint Information, or after transmitting message MATCH or NOMATCH after the processing and comparing of both FP and CC INFO in state With Credit Card Information And Personal Fingerprint Information is completed. Transition to state With Credit Card Information And Personal Fingerprint Information occurs when both FP and CC INFO have been obtained; transition to state With Credit Card Information occurs when CC INFO has been obtained and transition to state With Personal Fingerprint Information occurs when FP has been obtained.

Having described the invention with regard to certain specific embodiments thereof, it is to be understood that the description is not meant as a limitation, since further modifications may now suggest themselves to those skilled in the art, and it is intended to cover such modifications as fall within the scope of the appended claims.

What is claimed is:

1. A method for local credit card authentication comprising the steps of:
initiating a purchase transaction in which a purchaser provides credit card information at a purchaser location using standard magnetic strip technology;
transmitting the credit card and encoded biometric information, all resident on the credit card, to processing equipment;
collecting personal information using a scanning device employing optical, electrostatic or other image gathering and digitization technique;
processing and comparing personal information collected with biometric information stored on the card's magnetic strip using a device installed in series or integrated with a standard magnetic strip credit card reader,
said processing and comparing of said personal information includes the step of computing high pass filtering results with any filter kernel, low pass filtering results with any filter kernel or collections thereof,
said processing and comparing of said personal information includes the step of computing any statistical or digital signal or image processing metrics, statistics, measures, invariants, or other derivatives, including morphological characteristics, means, variances, deviations, vectors, tensors, correlation functions and the like, or combination or composition thereof, with the results of said filtering results,
said processing and comparing of said personal information excepts explicit ridge-counting algorithms, minutia categorizing algorithms and flow-field and pattern-mask identification techniques of the collected personal information;
transmitting a message noting match and allowing normal communications between the magnetic strip credit card reader, an electronic cash register or computer, or an acquiring bank or independent sales organization, or any combination thereof, upon successful match of biometrics information with personal information,
said transmitting of messages noting match is to the credit card reader, the acquiring bank or independent sales organization, or an electronic cash register or local computer, or any combination thereof;
transmitting a message noting the mismatch and halting normal communications between the magnetic strip credit card reader, an electronic cash register or computer, or an acquiring bank or independent sales organization, or any combination thereof, upon unsuccessful match of biometrics information with personal information,
said transmitting of messages noting mismatch is to the credit card reader, the acquiring bank or independent sales organization, or an electronic cash register or local computer, or any combination thereof.

2. The method of claim 1 wherein said personal information is one or more fingerprints and said biometric information is processed and encoded fingerprint information.

3. The method of claim 1 wherein said halting of normal communications may be overridden either by an electronic or physical signal.

4. The method of claim 1 wherein said processing and comparing of said biometric information involves the computation or comparison of hash function values of the computed statistical or digital signal or image processing metrics, statistics, measures, invariants or other derivatives with the information on the card.

5. The method of claim 1 wherein said transmitting steps includes transmission of an encryption token for use in encrypting information for transmission to or from said processing equipment during said transmitting steps.

6. The method of claim 5 wherein said encryption token contains unique information for one-time use only, such as date, time, location and the like.

7. A local credit card authentication system comprising:
means provided as a device for collecting and said processing at least one fingerprint image,
means provided in said device for said comparison of said processed at least one fingerprint image with said biometric information contained on the credit card;
means of connecting said device as an add-on unit or integrating said device with standard means for initiating or recording a credit card purchase transaction,
said means of connecting said device provided as interface ports or buses between said processing device and standard means for initiating a credit card purchase transaction or recording a credit card purchase transaction or between said processing device and standard telecommunications media connected to the acquiring bank or independent sales organization, or any combination thereof;
means for employing said means of connecting said device for the transmission of said biometric information to said processing device;
means for employing said means of connecting said device for the transmission of said messages noting match or said messages noting mismatch from said processing device;
means for employing said means of connecting said device for the forwarding of credit card information from the standard means for initiating a credit card purchase transaction or the standard means recording a credit card purchase transaction for the purposes of either completing or breaking a standard communications circuit used by the standard means for initiating a credit card purchase transaction or the standard means for recording a credit card purchase transaction and the acquiring bank or independent sales organization to broker a credit card transaction.
